(19) United States
(12) Patent Application Publication
(10) Pub. No.: US 2012/0162173 A1
(43) Pub. Date: Jun. 28, 2012

(54) DRIVING METHOD FOR A LIQUID CRYSTAL DISPLAY

(76) Inventors: Chin-An Tseng, Hsin-Chu (TW); Tien-Lun Ting, Hsin-Chu (TW); Yu-Ching Wu, Hsin-Chu (TW); Yi-Cheng Li, Hsin-Chu (TW); Wen-Hao Hsu, Hsin-Chu (TW); Yen-Heng Huang, Hsin-Chu (TW); Ming-Yung Huang, Hsin-Chu (TW)

(21) Appl. No.: 13/084,570

(22) Filed: Apr. 12, 2011

(30) Foreign Application Priority Data
Dec. 27, 2010 (TW) 099146063

(51) Int. Cl. G09G 3/36; G06F 3/038

(52) U.S. Cl. 345/211; 345/90

(57) ABSTRACT

A driving method for a liquid crystal display includes providing a first gate pulse to a first gate line for driving adjacent first and second subpixels to perform charging operations, providing a second gate pulse to a second gate line for driving adjacent third and fourth subpixels to perform charging operations, providing a third gate pulse to a third gate line for driving the second subpixel to perform a charge-sharing operation, and providing a fourth gate pulse to a fourth gate line for driving the fourth subpixel to perform a charge-sharing operation. The first and second gate lines are spaced out at least one gate line. The third gate line is adjacent to the first gate line. The fourth gate line is adjacent to the second gate line. The first gate pulse, the second gate pulse, the third gate pulse and the fourth gate pulse are sequentially triggered.

### BACKGROUND OF THE INVENTION

1. Field of the Invention

The present invention relates to a driving method, and more particularly, to a driving method for a liquid crystal display.

2. Description of the Prior Art

Liquid crystal displays (LCDs) have advantages of a thin profile, low power consumption, and low radiation, and are broadly adopted for application in media players, mobile phones, personal digital assistants (PDAs), computer displays, and flat screen televisions. The operation of a liquid crystal display is featured by modulating the voltage drop across opposite sides of a liquid crystal layer for twisting the angles of liquid crystal molecules in the liquid crystal layer so that the transmittance of the liquid crystal layer can be controlled for illustrating images with the aid of light source provided by a backlight module. In general, the liquid crystal display comprises plural pixel units, a source driver, and a gate driver. The source driver is utilized for providing plural data signals to be written into the pixel units. The gate driver functions to generate plural gate signals for controlling the operations of writing the data signals into the pixel units. Besides, it is well known that each pixel unit may comprise a first subpixel and a second subpixel for achieving a display feature with wide viewing angle, i.e. based on multi-domain vertical alignment (MVA) architecture. In the operation of an MVA-based liquid crystal display, after the first and second subpixels perform charging operations to generate a first subpixel voltage and a second subpixel voltage substantially identical to the first subpixel voltage according to one data signal and one gate signal, the second subpixel further performs a charge-sharing operation to lower the second subpixel voltage according to another gate signal, such that the transmittances of the first and second subpixels, corresponding to the data signal, are different for providing a display feature with wide viewing angle.

However, regarding the prior-art driving method of a gate driver, significant feed-through voltage shifts will occur to the first and second subpixel voltages due to the level switching of gate signals through capacitive coupling, and the feed-through voltages corresponding to the first and second subpixel voltages are different significantly, which leads to the phenomena of flickering and color-shift on the LCD screen. Further, concerning an LCD having color-filter on array (COA) architecture, i.e. integrating color filter structure into the substrate comprising pixel array, the event of different feed-through voltage shifts occurring to different subpixel voltages is even worse following different dielectric constants of filtering layers with different colors, which may worsen the phenomena of flickering and color-shift on the LCD screen.

FIG. 1 is a schematic diagram illustrating an embodiment of the pixel array circuit in a MVA/COA-based liquid crystal display. As shown in FIG. 1, the pixel array circuit 100 comprises a plurality of gate lines 110 for transmitting gate signals, a plurality of data lines 120 for transmitting data signals, and a plurality of pixel units 150. Each pixel unit 150 has a first subpixel 160 and a second subpixel 170. For instance, the pixel unit PXa has a first subpixel PSn−1_m and a second subpixel PSn_m, and the pixel unit PXb has a first subpixel PSn+1_m and a second subpixel PSn+2_m. The first subpixel 160 includes a first data switch 161, a first liquid crystal capacitor 162, a first storage capacitor 163 and a first parasitic capacitor 164. The second subpixel 170 includes a second data switch 171, a second liquid crystal capacitor 172, a second storage capacitor 173, a second parasitic capacitor 174, an auxiliary switch 176 and an auxiliary capacitor 177.

In the following, the pixel unit PXa is utilized for illustrating interconnections of each component in the pixel unit 150. The first data switch 161 comprises a first end electrically connected to the data line DLm for receiving a data signal SDm, a gate end electrically connected to the gate line GLn for receiving a gate signal SGn, and a second end electrically connected to the first pixel electrode 169 of the first subpixel PSn−1_m, the first liquid crystal capacitor 162 and the first storage capacitor 163. The first parasitic capacitor 164 is formed in a first overlapping area between the first pixel electrode 169 and the gate line GLn−1 which is arranged with a first color filtering layer 165 clamped between the first pixel electrode 169 and the gate line GLn−1. The second data switch 171 comprises a first end electrically connected to the data line DLm for receiving the data signal SDm, a gate end electrically connected to the gate line GLn for receiving the gate signal SGn, and a second end electrically connected to the second pixel electrode 179 of the second subpixel PSn_m, the second liquid crystal capacitor 172 and the second storage capacitor 173. The second parasitic capacitor 174 is formed in a second overlapping area between the second pixel electrode 179 and the gate line GLn+1 which is arranged with a second color filtering layer 175 clamped between the second pixel electrode 179 and the gate line GLn+1. The auxiliary switch 176 comprises a first end electrically connected to the second end of the second data switch 171, a gate end electrically connected to the gate line GLn+1 for receiving the gate signal SGn+1, and a second end electrically connected to the auxiliary capacitor 177. The interconnections of each component in other pixel units 150 are similar to those of the pixel unit PXa and can be inferred by analogy.

In the operation of the pixel unit PXa, when the first data switch 161 and the second data switch 171 are turned on by the gate pulse of the gate signal SGn, the first subpixel PSn−1_m performs a charging operation for generating a first subpixel voltage Vp1 according to the data signal SDm, and the second subpixel PSn_m performs a charging operation for generating a second subpixel voltage Vp2 according to the data signal SDm. At this time, the second subpixel voltage Vp2 is substantially identical to the first subpixel voltage Vp1. When the auxiliary switch 176 is turned on by the gate pulse of the gate signal SGn+1, the second subpixel PSn_m performs a charge-sharing operation for adjusting the second subpixel voltage Vp2. Then, the second subpixel voltage Vp2 is different from the first subpixel voltage Vp1, such that the transmittances of the first subpixel PSn−1_m and the second subpixel PSn_m, corresponding to the data signal SDm, are different for providing a display feature with wide viewing angle.

FIG. 2 is a schematic diagram showing related signal waveforms regarding the operation of the pixel array circuit 100 illustrated in FIG. 1 based on a prior-art driving method, having time along the abscissa. The signal waveforms in FIG. 2, from top to bottom, are the gate signal SGn, the gate signal SGn+1, the gate signal SGn+2, the gate signal SGn+3, the data signal SDm, the first subpixel voltage Vp1, the second subpixel voltage Vp2, the first subpixel voltage Vp3, and the second subpixel voltage Vp4. Referring to FIG. 2 in conjunction with FIG. 1, during an interval T1, the first gate pulse of the gate signal SGn is utilized for driving the first subpixel PSn−1_m and the second subpixel PSn_m to perform charging operations for pulling the first subpixel voltage Vp1 and the second subpixel voltage Vp2 up to a voltage Vs1 according to the data signal SDm. During an interval T2, the second gate pulse of the gate signal SGn+1 is utilized for driving the second subpixel PSn_m to perform a charge-sharing operation for pulling the second subpixel voltage Vp2 down to a voltage Vs12. Besides, during the interval T2, the third gate pulse of the gate signal SGn+2 is utilized for driving the first subpixel PSn+1_m and the second subpixel PSn+2 m to perform charging operations for pulling the first subpixel voltage Vp3 and the second subpixel voltage Vp4 up to a voltage Vs2 according to the data signal SDm. During an interval T3, the fourth gate pulse of the gate signal SGn+3 is utilized for driving the second subpixel PSn+2 m to perform a charge-sharing operation for pulling the second subpixel voltage Vp4 down to a voltage Vs22.

However, regarding the aforementioned operation based on the prior-art driving method, the first subpixel voltage Vp3 is pulled down by the falling edge of the second gate pulse through coupling of the first parasitic capacitor 164 in the first subpixel PSn+1_m, and is further pulled down by the falling edge of the third gate pulse through coupling of the device capacitor of the first data switch 161 in the first subpixel PSn+1_m, which results in a significant feed-through voltage shift of the first subpixel voltage Vp3. It is noted that the first data switch 161 of the first subpixel PSn+1_m is turned on during the interval T2, and therefore the rising edge of the second gate pulse has no effect on the first subpixel voltage Vp3. Besides, the second subpixel voltage Vp4 is also pulled down by the falling edge of the third gate pulse through coupling of the device capacitor of the second data switch 171 in the second subpixel PSn+2_m. The rising and falling edges of the fourth gate pulse are employed respectively to pull up and to pull down the second subpixel voltage Vp4. Consequently, the effects of the rising and falling edges of the fourth gate pulse on the second subpixel voltage Vp4 are compensated for each other, and therefore the feed-through voltage shift of the second subpixel voltage Vp4 is caused only by the falling edge of the third gate pulse. That is, the prior-art driving method not only leads to the significant feed-through voltage shift of the first subpixel voltage Vp3, but also results in significant feed-through voltage difference between the first subpixel voltage Vp3 and the second subpixel voltage Vp4, which causes the phenomena of flickering and color-shift on the LCD screen. Further, since capacitances of the first parasitic capacitor 164 and the second parasitic capacitor 174 in adjacent pixel units 150 are different due to different colors of the first color filtering layer 165 and the second color filtering layer 175, and therefore the event of different feed-through voltage shifts occurring to the first subpixel voltage Vp3 and the second subpixel voltage Vp4 is even worse, which may worsen the phenomena of flickering and color-shift on the LCD screen.

### SUMMARY OF THE INVENTION

In accordance with an embodiment of the present invention, a driving method for driving a liquid crystal display having plural gate lines and plural subpixels is provided. The driving method comprises: providing a first gate pulse to a first gate line of the gate lines during a first interval; driving adjacent first and second subpixels of the subpixels to perform charging operations according to the first gate pulse during the first interval, wherein the first and second subpixels are both electrically connected to the first gate line; providing a second gate pulse to a second gate line of the gate lines during a second interval, wherein the second and first gate lines are not adjacent to each other, and a fore-edge of the second gate pulse is following a fore-edge of the first gate pulse; driving adjacent third and fourth subpixels of the subpixels to perform charging operations according to the second gate pulse during the second interval, wherein the third and fourth subpixels are both electrically connected to the second gate line; providing a third gate pulse to a third gate line of the gate lines during a third interval, wherein the third gate line is adjacent to the first gate line, and a fore-edge of the third gate pulse is following the fore-edge of the second gate pulse; driving the second subpixel to perform a charge-sharing operation according to the third gate pulse during the third interval, wherein the second subpixel is electrically connected to the third gate line; providing a fourth gate pulse to a fourth gate line of the gate lines during a fourth interval, wherein the fourth gate line is adjacent to the second gate line, and a fore-edge of the fourth gate pulse is following the fore-edge of the third gate pulse; and driving the fourth subpixel to perform a charge-sharing operation according to the fourth gate pulse during the fourth interval, wherein the fourth subpixel is electrically connected to the fourth gate line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an embodiment of the pixel array circuit in a MVA/COA-based liquid crystal display.

FIG. 2 is a schematic diagram showing related signal waveforms regarding the operation of the pixel array circuit illustrated in FIG. 1 based on a prior-art driving method, having time along the abscissa.

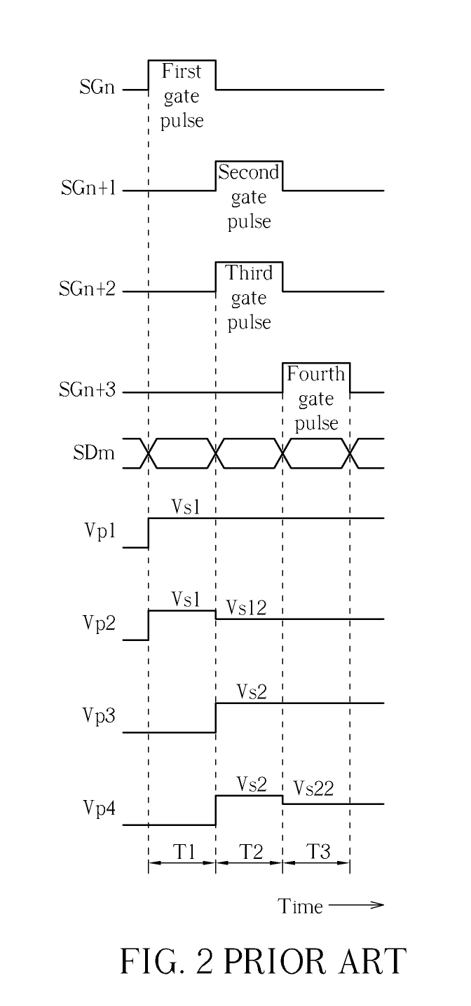

FIG. 3 is a schematic diagram showing related signal waveforms regarding the operation of the pixel array circuit illustrated in FIG. 1 based on a driving method in accordance with a first embodiment of the present invention, having time along the abscissa.

FIG. 4 is a schematic diagram showing related signal waveforms regarding the operation of the pixel array circuit illustrated in FIG. 1 based on a driving method in accordance with a second embodiment of the present invention, having time along the abscissa.

FIG. 5 is a schematic diagram showing related signal waveforms regarding the operation of the pixel array circuit illustrated in FIG. 1 based on a driving method in accordance with a third embodiment of the present invention, having time along the abscissa.

FIG. 6 is a schematic diagram showing related signal waveforms regarding the operation of the pixel array circuit illustrated in FIG. 1 based on a driving method in accordance with a fourth embodiment of the present invention, having time along the abscissa.

### DETAILED DESCRIPTION

Hereinafter, preferred embodiments of the present invention will be described in detail with reference to the accompanying drawings. Here, it is to be noted that the present invention is not limited thereto.

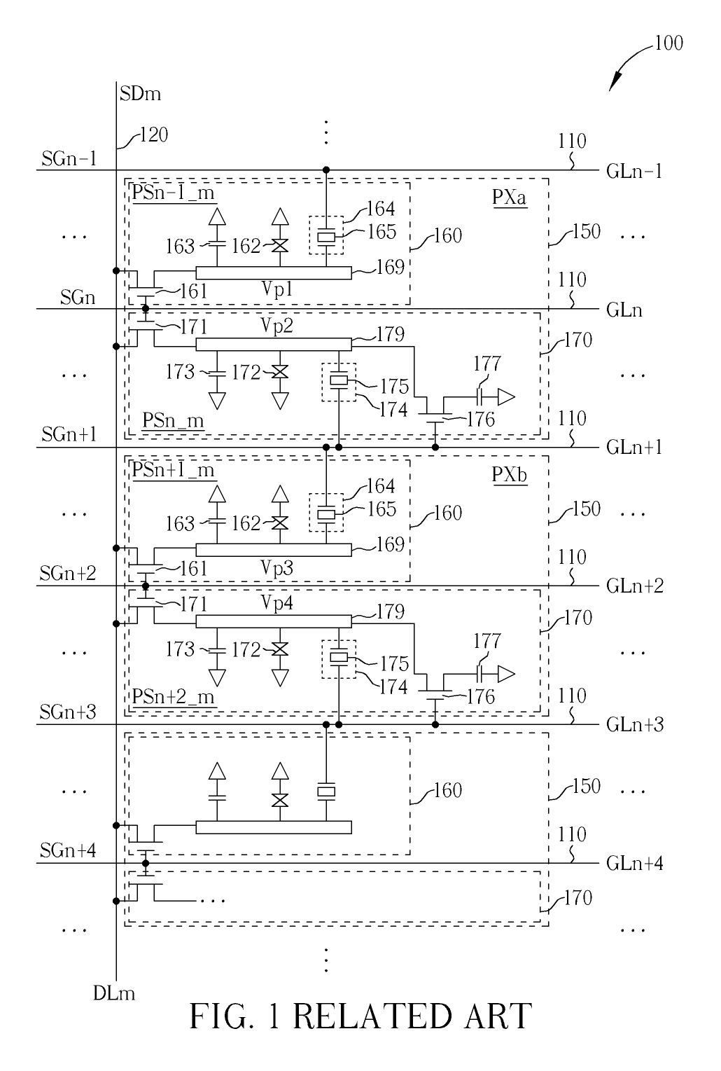

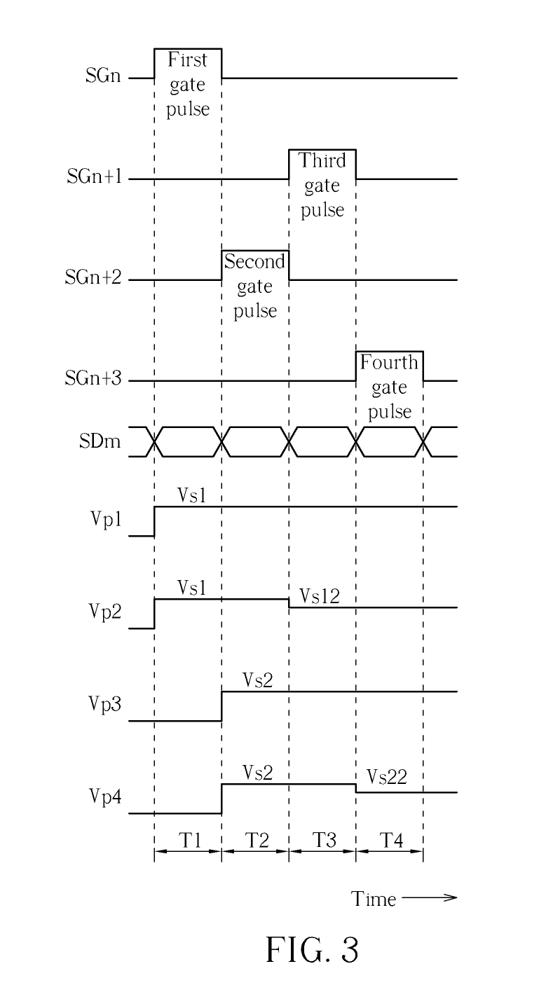

FIG. 3 is a schematic diagram showing related signal waveforms regarding the operation of the pixel array circuit 100 illustrated in FIG. 1 based on a driving method in accordance with a first embodiment of the present invention, having time along the abscissa. The signal waveforms in FIG. 3, from top to bottom, are the gate signal SGn, the gate signal SGn+1, the gate signal SGn+2, the gate signal SGn+3, the data signal SDm, the first subpixel voltage Vp1, the second subpixel voltage Vp2, the first subpixel voltage Vp3, and the second subpixel voltage Vp4. Referring to FIG. 3 in conjunction with FIG. 1, during an interval T1, the first gate pulse of the gate signal SGn is utilized for driving adjacent subpixels PSn−1_m and PSn_m to perform charging operations for pulling the first subpixel voltage Vp1 and the second subpixel voltage Vp2 up to a voltage Vs1 according to the data signal SDm. During an interval T2, the second gate pulse of the gate signal SGn+2 is utilized for driving adjacent subpixels PSn+1_m and PSn+2_m to perform charging operations for pulling the first subpixel voltage Vp3 and the second subpixel voltage Vp4 up to a voltage Vs2 according to the data signal SDm. The fore-edge of the second gate pulse is following the fore-edge of the first gate pulse. It is noted that the gate line GLn+2 for transmitting the second gate pulse and the gate line GLn for transmitting the first gate pulse are spaced out at least one gate line, i.e. not limited to the separation of just one gate line shown in FIG. 1. The first subpixel PSn+1_m and the second subpixel PSn_m is adjacent or separated by at least one subpixel. The first gate pulse and the second gate pulse are non-overlapped.

During an interval T3, the third gate pulse of the gate signal SGn+1 is utilized for driving the second subpixel PSn_m to perform a charge-sharing operation for pulling the second subpixel voltage Vp2 down to a voltage Vs12. The third gate pulse and the second gate pulse are non-overlapped, and the fore-edge of the third gate pulse is following the fore-edge of the second gate pulse. During an interval T4, the fourth gate pulse of the gate signal SGn+3 is utilized for driving the second subpixel PSn+2_m to perform a charge-sharing operation for pulling the second subpixel voltage Vp4 down to a voltage Vs22. The fore-edge of the fourth gate pulse is following the fore-edge of the third gate pulse. The fourth gate pulse and the third gate pulse are non-overlapped or partly overlapped. It is noted that the gate line GLn+1 for transmitting the third gate pulse is adjacent to the gate line GLn for transmitting the first gate pulse, and the gate line GLn+3 for transmitting the fourth gate pulse is adjacent to the gate line GLn+2 for transmitting the second gate pulse.

Regarding the aforementioned operation based on the first embodiment of the driving method according to the present invention, while the first subpixel voltage Vp3 is pulled down by the falling edge of the second gate pulse through coupling of the device capacitor of the first data switch 161 in the first subpixel PSn+1_m, the first data switch 161 of the first subpixel PSn+1_m is turned off by the falling edge of the second gate pulse, and therefore the rising and falling edges of the third gate pulse can be employed respectively to pull up and to pull down the first subpixel voltage Vp3 through coupling of the first parasitic capacitor 164 in the first subpixel PSn+1_m. That is, the effects of the rising and falling edges of the third gate pulse on the first subpixel voltage Vp3 are compensated for each other. For that reason, the feed-through voltage shift of the first subpixel voltage Vp3 is caused only by the falling edge of the second gate pulse.

Besides, the second subpixel voltage Vp4 is also pulled down by the falling edge of the second gate pulse through coupling of the device capacitor of the second data switch 171 in the second subpixel PSn+2_m. Likewise, the rising and falling edges of the fourth gate pulse can be employed respectively to pull up and to pull down the second subpixel voltage Vp4, such that the effects of the rising and falling edges of the fourth gate pulse on the second subpixel voltage Vp4 are compensated for each other. Consequently, the feed-through voltage shift of the second subpixel voltage Vp4 is caused only by the falling edge of the second gate pulse. That is, the feed-through voltage shifts of the first subpixel voltage Vp3 and the second subpixel voltage Vp4 are both caused by the falling edge of gate pulse through coupling of the device capacitor of data switch, and are not affected by capacitance difference of parasitic capacitors in different pixel units 150. In view of that, compared with the prior art, the feed-through voltage difference between the first subpixel voltage Vp3 and the second subpixel voltage Vp4 is much smaller. In summary, the driving method according to the first embodiment of the present invention not only significantly reduces the feed-through voltage shift of each first subpixel voltage, but also significantly reduces the feed-through voltage difference between the first and second subpixel voltages of each pixel unit 150, which in turn significantly mitigates the phenomena of flickering and color-shift on the LCD screen for achieving high display quality.

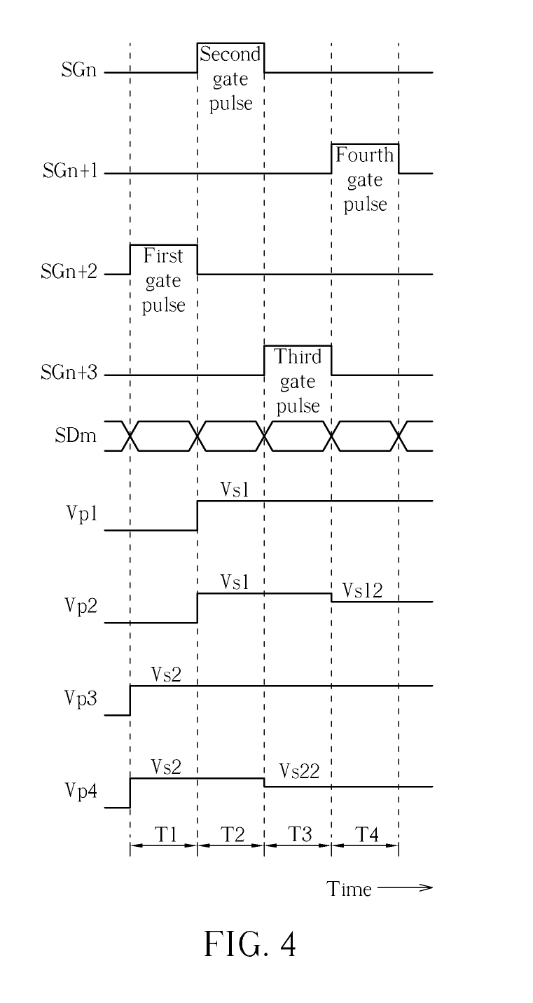

FIG. 4 is a schematic diagram showing related signal waveforms regarding the operation of the pixel array circuit 100 illustrated in FIG. 1 based on a driving method in accordance with a second embodiment of the present invention, having time along the abscissa. The signal waveforms in FIG. 4, from top to bottom, are the gate signal SGn, the gate signal SGn+1, the gate signal SGn+2, the gate signal SGn+3, the data signal SDm, the first subpixel voltage Vp1, the second subpixel voltage Vp2, the first subpixel voltage Vp3, and the second subpixel voltage Vp4. Referring to FIG. 4 in conjunction with FIG. 1, during an interval T1, the first gate pulse of the gate signal SGn+2 is utilized for driving adjacent subpixels PSn+1_m and PSn+2_m to perform charging operations for pulling the first subpixel voltage Vp3 and the second subpixel voltage Vp4 up to a voltage Vs2 according to the data signal SDm. During an interval T2, the second gate pulse of the gate signal SGn is utilized for driving adjacent subpixels PSn−1_m and PSn_m to perform charging operations for pulling the first subpixel voltage Vp1 and the second subpixel voltage Vp2 up to a voltage Vs1 according to the data signal SDm. The fore-edge of the second gate pulse is following the fore-edge of the first gate pulse. It is noted that the gate line GLn for transmitting the second gate pulse and the gate line GLn+2 for transmitting the first gate pulse are spaced out at least one gate line, i.e. not limited to the separation of just one gate line shown in FIG. 1. The first subpixel PSn+1_m and the second subpixel PSn_m is adjacent or separated by at least one subpixel. The first gate pulse and the second gate pulse are non-overlapped.

During an interval T3, the third gate pulse of the gate signal SGn+3 is utilized for driving the second subpixel PSn+2_m to perform a charge-sharing operation for pulling the second subpixel voltage Vp4 down to a voltage Vs22. The fore-edge of the third gate pulse is following the fore-edge of the second gate pulse. The third gate pulse and the second gate pulse are non-overlapped or partly overlapped. During an interval T4, the fourth gate pulse of the gate signal SGn+1 is utilized for driving the second subpixel PSn_m to perform a charge-sharing operation for pulling the second subpixel voltage Vp2 down to a voltage Vs12. The fore-edge of the fourth gate pulse is following the fore-edge of the third gate pulse. The fourth gate pulse and the third gate pulse are non-overlapped or partly overlapped. The third gate pulse and the first gate pulse are non-overlapped. It is noted that the gate line GLn+3 for transmitting the third gate pulse is adjacent to the gate line GLn+2 for transmitting the first gate pulse, and the gate line GLn+1 for transmitting the fourth gate pulse is adjacent to the gate line GLn for transmitting the second gate pulse.

Regarding the aforementioned operation based on the second embodiment of the driving method according to the present invention, while the first subpixel voltage Vp3 is pulled down by the falling edge of the first gate pulse through coupling of the device capacitor of the first data switch 161 in the first subpixel PSn+1_m, the first data switch 161 of the first subpixel PSn+1_m is turned off by the falling edge of the first gate pulse, and therefore the rising and falling edges of the fourth gate pulse can be employed respectively to pull up and to pull down the first subpixel voltage Vp3 through coupling of the first parasitic capacitor 164 in the first subpixel PSn+1_m. That is, the effects of the rising and falling edges of the fourth gate pulse on the first subpixel voltage Vp3 are compensated for each other. For that reason, the feed-through voltage shift of the first subpixel voltage Vp3 is caused only by the falling edge of the first gate pulse.

Besides, the second subpixel voltage Vp4 is also pulled down by the falling edge of the first gate pulse through coupling of the device capacitor of the second data switch 171 in the second subpixel PSn+2_m. Likewise, the rising and falling edges of the third gate pulse are employed respectively to pull up and to pull down the second subpixel voltage Vp4, such that the effects of the rising and falling edges of the third gate pulse on the second subpixel voltage Vp4 are compensated for each other. Consequently, the feed-through voltage shift of the second subpixel voltage Vp4 is caused only by the falling edge of the first gate pulse. That is, the feed-through voltage shifts of the first subpixel voltage Vp3 and the second subpixel voltage Vp4 are both caused by the falling edge of gate pulse through coupling of the device capacitor of data switch, and are not affected by capacitance difference of parasitic capacitors in different pixel units 150. In view of that, compared with the prior art, the feed-through voltage difference between the first subpixel voltage Vp3 and the second subpixel voltage Vp4 is much smaller. In summary, the driving method according to the second embodiment of the present invention not only significantly reduces the feed-through voltage shift of each first subpixel voltage, but also significantly reduces the feed-through voltage difference between the first and second subpixel voltages of each pixel unit 150, which in turn significantly mitigates the phenomena of flickering and color-shift on the LCD screen for achieving high display quality.

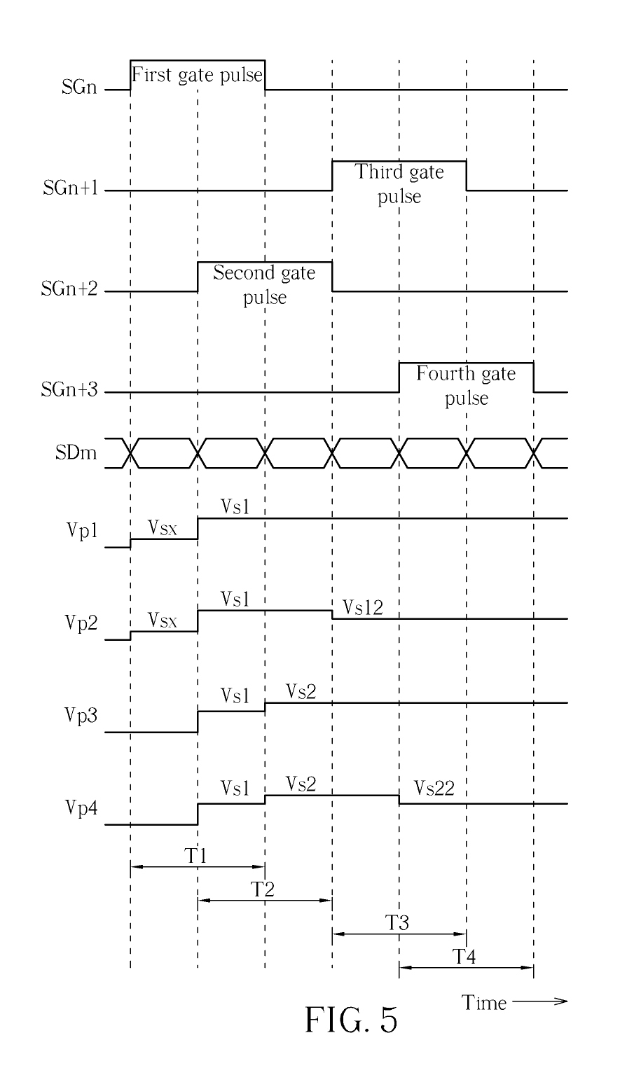

FIG. 5 is a schematic diagram showing related signal waveforms regarding the operation of the pixel array circuit 100 illustrated in FIG. 1 based on a driving method in accordance with a third embodiment of the present invention, having time along the abscissa. The signal waveforms in FIG. 5, from top to bottom, are the gate signal SGn, the gate signal SGn+1, the gate signal SGn+2, the gate signal SGn+3, the data signal SDm, the first subpixel voltage Vp1, the second subpixel voltage Vp2, the first subpixel voltage Vp3, and the second subpixel voltage Vp4. Referring to FIG. 5 in conjunction with FIG. 1, during the first half period of an interval T1, the first gate pulse of the gate signal SGn is utilized for driving adjacent subpixels PSn−1_m and PSn_m to perform pre-charging operations for pulling the first subpixel voltage Vp1 and the second subpixel voltage Vp2 up to a voltage Vsx according to the data signal SDm. During the second half period of the interval T1, the first gate pulse is utilized for driving the subpixels PSn−1_m and PSn_m to perform charging operations for pulling the first subpixel voltage Vp1 and the second subpixel voltage Vp2 up to a voltage Vs1 according to the data signal SDm.

The second half period of the interval T1 and the first half period of a second interval T2 are overlapped, and the second gate pulse of the gate signal SGn+2 partly overlaps the first gate pulse. During the first half period of the interval T2, the second gate pulse is utilized for driving adjacent subpixels PSn+1_m and PSn+2_m to perform pre-charging operations for pulling the first subpixel voltage Vp3 and the second subpixel voltage Vp4 up to the voltage Vs1 according to the data signal SDm. During the second half period of the interval T2, the second gate pulse is utilized for driving the subpixels PSn+1_m and PSn+2_m to perform charging operations for pulling the first subpixel voltage Vp3 and the second subpixel voltage Vp4 up to a voltage Vs2 according to the data signal SDm. It is noted that the gate line GLn+2 for transmitting the second gate pulse and the gate line GLn for transmitting the first gate pulse are spaced out at least one gate line, i.e. not limited to the separation of just one gate line shown in FIG. 1. The first subpixel PSn+1_m and the second subpixel PSn_m is adjacent or separated by at least one subpixel.

During an interval T3, the third gate pulse of the gate signal SGn+1 is utilized for driving the second subpixel PSn_m to perform a charge-sharing operation for pulling the second subpixel voltage Vp2 down to a voltage Vs12. The third gate pulse and the second gate pulse are non-overlapped, and the fore-edge of the third gate pulse is following the fore-edge of the second gate pulse. During an interval T4, the fourth gate pulse of the gate signal SGn+3 is utilized for driving the second subpixel PSn+2_m to perform a charge-sharing operation for pulling the second subpixel voltage Vp4 down to a voltage Vs22. The fore-edge of the fourth gate pulse is following the fore-edge of the third gate pulse. The fourth gate pulse and the third gate pulse are non-overlapped or partly overlapped. It is noted that the gate line GLn+1 for transmitting the third gate pulse is adjacent to the gate line GLn for transmitting the first gate pulse, and the gate line GLn+3 for transmitting the fourth gate pulse is adjacent to the gate line GLn+2 for transmitting the second gate pulse.

Regarding the aforementioned operation based on the third embodiment of the driving method according to the present invention, while the first subpixel voltage Vp3 is pulled down by the falling edge of the second gate pulse through coupling of the device capacitor of the first data switch 161 in the first subpixel PSn+1_m, the first data switch 161 of the first subpixel PSn+1_m is turned off by the falling edge of the second gate pulse, and therefore the rising and falling edges of the third gate pulse can be employed respectively to pull up and to pull down the first subpixel voltage Vp3 through coupling of the first parasitic capacitor 164 in the first subpixel PSn+1_m. That is, the effects of the rising and falling edges of the third gate pulse on the first subpixel voltage Vp3 are compensated for each other. For that reason, the feed-through voltage shift of the first subpixel voltage Vp3 is caused only by the falling edge of the second gate pulse.

Besides, the second subpixel voltage Vp4 is also pulled down by the falling edge of the second gate pulse through coupling of the device capacitor of the second data switch 171 in the second subpixel PSn+2_m. Likewise, the rising and falling edges of the fourth gate pulse are employed respectively to pull up and to pull down the second subpixel voltage Vp4, such that the effects of the rising and falling edges of the fourth gate pulse on the second subpixel voltage Vp4 are compensated for each other. Consequently, the feed-through voltage shift of the second subpixel voltage Vp4 is caused only by the falling edge of the second gate pulse. That is, the feed-through voltage shifts of the first subpixel voltage Vp3 and the second subpixel voltage Vp4 are both caused by the falling edge of gate pulse through coupling of the device capacitor of data switch, and are not affected by capacitance difference of parasitic capacitors in different pixel units 150. In view of that, compared with the prior art, the feed-through voltage difference between the first subpixel voltage Vp3 and the second subpixel voltage Vp4 is much smaller. In summary, the driving method according to the third embodiment of the present invention not only significantly reduces the feed-through voltage shift of each first subpixel voltage, but also significantly reduces the feed-through voltage difference between the first and second subpixel voltages of each pixel unit 150, which in turn significantly mitigates the phenomena of flickering and color-shift on the LCD screen for achieving high display quality.

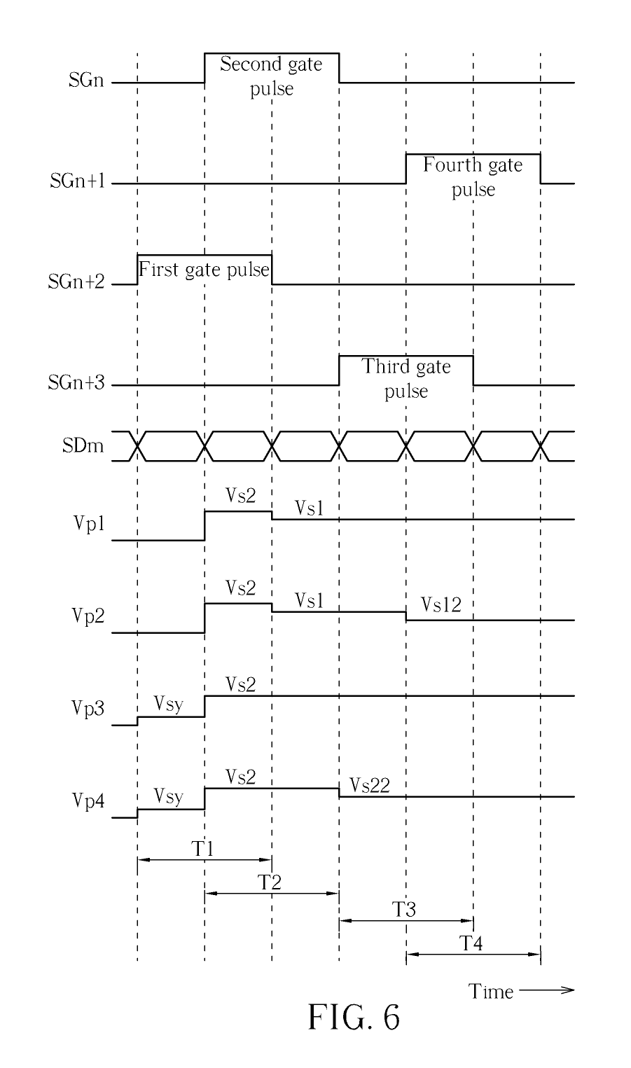

FIG. 6 is a schematic diagram showing related signal waveforms regarding the operation of the pixel array circuit 100 illustrated in FIG. 1 based on a driving method in accordance with a fourth embodiment of the present invention, having time along the abscissa. The signal waveforms in FIG. 6, from top to bottom, are the gate signal SGn, the gate signal SGn+1, the gate signal SGn+2, the gate signal SGn+3, the data signal SDm, the first subpixel voltage Vp1, the second subpixel voltage Vp2, the first subpixel voltage Vp3, and the second subpixel voltage Vp4. Referring to FIG. 6 in conjunction with FIG. 1, during the first half period of an interval T1, the first gate pulse of the gate signal SGn+2 is utilized for driving adjacent subpixels PSn+1_m and PSn+2_m to perform pre-charging operations for pulling the first subpixel voltage Vp3 and the second subpixel voltage Vp4 up to a voltage Vsy according to the data signal SDm. During the second half period of the interval T1, the first gate pulse is utilized for driving the subpixels PSn+1_m and PSn+2_m to perform charging operations for pulling the first subpixel voltage Vp3 and the second subpixel voltage Vp4 up to a voltage Vs2 according to the data signal SDm.

The second half period of the interval T1 and the first half period of a second interval T2 are overlapped, and the second gate pulse of the gate signal SGn partly overlaps the first gate pulse. During the first half period of the interval T2, the second gate pulse is utilized for driving adjacent subpixels PSn−1_m and PSn_m to perform pre-charging operations for pulling the first subpixel voltage Vp1 and the second subpixel voltage Vp2 up to the voltage Vs2 according to the data signal SDm. During the second half period of the interval T2, the second gate pulse is utilized for driving the subpixels PSn−1_m and PSn_m to perform charging operations for pulling the first subpixel voltage Vp1 and the second subpixel voltage Vp2 down to a voltage Vs1 according to the data signal SDm. It is noted that the gate line GLn for transmitting the second gate pulse and the gate line GLn+2 for transmitting the first gate pulse are spaced out at least one gate line, i.e. not limited to the separation of just one gate line shown in FIG. 1. The first subpixel PSn+1_m and the second subpixel PSn_m is adjacent or separated by at least one subpixel.

During an interval T3, the third gate pulse of the gate signal SGn+3 is utilized for driving the second subpixel PSn+2_m to perform a charge-sharing operation for pulling the second subpixel voltage Vp4 down to a voltage Vs22. The fore-edge of the third gate pulse is following the fore-edge of the second gate pulse. The third gate pulse and the second gate pulse are non-overlapped or partly overlapped. During an interval T4, the fourth gate pulse of the gate signal SGn+1 is utilized for driving the second subpixel PSn_m to perform a charge-sharing operation for pulling the second subpixel voltage Vp2 down to a voltage Vs12. The fore-edge of the fourth gate pulse is following the fore-edge of the third gate pulse. The fourth gate pulse and the third gate pulse are non-overlapped or partly overlapped. The third gate pulse and the first gate pulse are non-overlapped. It is noted that the gate line GLn+3 for transmitting the third gate pulse is adjacent to the gate line GLn+2 for transmitting the first gate pulse, and the gate line GLn+1 for transmitting the fourth gate pulse is adjacent to the gate line GLn for transmitting the second gate pulse.

Regarding the aforementioned operation based on the fourth embodiment of the driving method according to the present invention, while the first subpixel voltage Vp3 is pulled down by the falling edge of the first gate pulse through coupling of the device capacitor of the first data switch 161 in the first subpixel PSn+1_m, the first data switch 161 of the first subpixel PSn+1_m is turned off by the falling edge of the first gate pulse, and therefore the rising and falling edges of the fourth gate pulse can be employed respectively to pull up and to pull down the first subpixel voltage Vp3 through coupling of the first parasitic capacitor 164 in the first subpixel PSn+1_m. That is, the effects of the rising and falling edges of the fourth gate pulse on the first subpixel voltage Vp3 are compensated for each other. For that reason, the feed-through voltage shift of the first subpixel voltage Vp3 is caused only by the falling edge of the first gate pulse.

Besides, the second subpixel voltage Vp4 is also pulled down by the falling edge of the first gate pulse through coupling of the device capacitor of the second data switch 171 in the second subpixel PSn+2_m. Likewise, the rising and falling edges of the third gate pulse are employed respectively to pull up and to pull down the second subpixel voltage Vp4, such that the effects of the rising and falling edges of the third gate pulse on the second subpixel voltage Vp4 are compensated for each other. Consequently, the feed-through voltage shift of the second subpixel voltage Vp4 is caused only by the falling edge of the first gate pulse. That is, the feed-through voltage shifts of the first subpixel voltage Vp3 and the second subpixel voltage Vp4 are both caused by the falling edge of gate pulse through coupling of the device capacitor of data switch, and are not affected by capacitance difference of parasitic capacitors in different pixel units 150. In view of that, compared with the prior art, the feed-through voltage difference between the first subpixel voltage Vp3 and the second subpixel voltage Vp4 is much smaller. In summary, the driving method according to the fourth embodiment of the present invention not only significantly reduces the feed-through voltage shift of each first subpixel voltage, but also significantly reduces the feed-through voltage difference between the first and second subpixel voltages of each pixel unit 150, which in turn significantly mitigates the phenomena of flickering and color-shift on the LCD screen for achieving high display quality.

To sum up, the driving method of the present invention for driving an LCD is capable of significantly reducing the feed-through voltage shift of each first subpixel voltage, and is also capable of significantly reducing the feed-through voltage difference between the first and second subpixel voltages of each pixel unit, i.e. with uniform feed-through voltage, thereby significantly mitigating the phenomena of flickering and color-shift on the LCD screen for achieving high display quality.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A driving method for driving a liquid crystal display having plural gate lines and plural subpixels, the driving method comprising:
providing a first gate pulse to a first gate line of the gate lines during a first interval;
driving adjacent first and second subpixels of the subpixels to perform charging operations according to the first gate pulse during the first interval, wherein the first and second subpixels are both electrically connected to the first gate line;
providing a second gate pulse to a second gate line of the gate lines during a second interval, wherein the second and first gate lines are not adjacent to each other, and a fore-edge of the second gate pulse is following a fore-edge of the first gate pulse;
driving adjacent third and fourth subpixels of the subpixels to perform charging operations according to the second gate pulse during the second interval, wherein the third and fourth subpixels are both electrically connected to the second gate line;
providing a third gate pulse to a third gate line of the gate lines during a third interval, wherein the third gate line is adjacent to the first gate line, and a fore-edge of the third gate pulse is following the fore-edge of the second gate pulse;
driving the second subpixel to perform a charge-sharing operation according to the third gate pulse during the third interval, wherein the second subpixel is electrically connected to the third gate line;
providing a fourth gate pulse to a fourth gate line of the gate lines during a fourth interval, wherein the fourth gate line is adjacent to the second gate line, and a fore-edge of the fourth gate pulse is following the fore-edge of the third gate pulse; and
driving the fourth subpixel to perform a charge-sharing operation according to the fourth gate pulse during the fourth interval, wherein the fourth subpixel is electrically connected to the fourth gate line.

2. The driving method of claim 1, wherein the second gate pulse and the first gate pulse are non-overlapped.

3. The driving method of claim 1, wherein the second gate pulse and the first gate pulse are partly overlapped.

4. The driving method of claim 1, wherein the third gate pulse and the second gate pulse are non-overlapped.

5. The driving method of claim 1, wherein the third gate pulse and the second gate pulse are partly overlapped.

6. The driving method of claim 5, wherein the third gate pulse and the first gate pulse are non-overlapped.

7. The driving method of claim 1, wherein the fourth gate pulse and the third gate pulse are non-overlapped.

8. The driving method of claim 1, wherein the fourth gate pulse and the third gate pulse are partly overlapped.

9. The driving method of claim 1, wherein providing the third gate pulse to the third gate line comprises providing the third gate pulse to the third gate line adjacent to the second gate line.

10. The driving method of claim 1, wherein providing the third gate pulse to the third gate line comprises providing the third gate pulse to the third gate line not adjacent to the second gate line.

11. The driving method of claim 1, wherein providing the fourth gate pulse to the fourth gate line comprises providing the fourth gate pulse to the fourth gate line adjacent to the first gate line.

12. The driving method of claim 1, wherein providing the fourth gate pulse to the fourth gate line comprises providing the fourth gate pulse to the fourth gate line not adjacent to the first gate line.

13. The driving method of claim 1, wherein providing the fourth gate pulse to the fourth gate line comprises providing the fourth gate pulse to the fourth gate line not adjacent to the third gate line.

14. The driving method of claim 1, wherein driving the third subpixel to perform the charging operation according to the second gate pulse comprises driving the third subpixel adjacent to the second subpixel to perform the charging operation according to the second gate pulse.

15. The driving method of claim 1, wherein driving the third subpixel to perform the charging operation according to the second gate pulse comprises driving the third subpixel not adjacent to the second subpixel to perform the charging operation according to the second gate pulse.

16. The driving method of claim 1, wherein driving the fourth subpixel to perform the charging operation according to the second gate pulse comprises driving the fourth subpixel adjacent to the first subpixel to perform the charging operation according to the second gate pulse.

17. The driving method of claim 1, wherein driving the fourth subpixel to perform the charging operation according to the second gate pulse comprises driving the fourth subpixel not adjacent to the first subpixel to perform the charging operation according to the second gate pulse.

18. The driving method of claim 1, wherein driving the fourth subpixel to perform the charging operation according to the second gate pulse comprises driving the fourth subpixel not adjacent to the second subpixel to perform the charging operation according to the second gate pulse.
